(19) United States
(12) Patent Application Publication
(10) Pub. No.: US 2009/0307607 A1
(43) Pub. Date: Dec. 10, 2009

(54) Digital Notes

(75) Inventors: Troy A. Schauls, Seattle, WA (US); Steven Karl Abrahams, Seattle, WA (US); Asta J. Roseway, Redmond, WA (US); Ethan Ray, Redmond, WA (US); Carmen Zlateff, Kirkland, WA (US); Rodger W. Benson, Seattle, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/136,658

(22) Filed: Jun. 10, 2008

(51) Int. Cl. G06F 3/048

(52) U.S. Cl. 715/752

(57) ABSTRACT

Techniques described herein allow for displaying a real-time communication client associated with a first user, the real-time communication client configured to receive an input from the first user and send, in response, a digital note to a second user. The real-time communication client may be configured to send the digital note to a desktop of the second user, a calendar of the second user, a real-time communication client of the second user, and a profile of the second user, potentially among other locations. These tools may also display, on the real-time communication client, one or more digital notes that have been sent by one or more other users and received at the real-time communication client associated with the first user. These notes may be displayed individually or collectively in the form of a notebook.

### BACKGROUND

Current electronic communications systems offer both synchronous and asynchronous conversation. For instance, instant messaging services allow users to communicate with one another in substantially real time. When a user sends an instant message to another user, the instant message typically appears on the screen of the recipient if he or she is online. These instant messages typically comprise a conversation window and a text box. Because of this format, instant messages generally comprise text and other static content. Additionally, the format of instant messages typically causes the recipient to feel a need to respond to the received message.

Email messaging systems and social networking sites, meanwhile, exemplify communications systems that enable asynchronous conversation. In the example of email, a received message typically routes to an inbox of a user to whom the email was addressed. This message then resides in the inbox until the user opens and reads at the message, at which point the receiving user may choose to respond to the sending user. Social networking sites, meanwhile, allow users to post messages to other users' online profiles. Again, however, these messages sit in a corresponding profile until the corresponding user views his or her profile.

Current communications systems therefore leave somewhat of a gap between these synchronous and asynchronous systems.

### SUMMARY

This document describes tools for displaying a real-time communication client associated with a first user, the real-time communication client configured to receive an input from the first user and send, in response, a digital note to a second user. The real-time communication client may be configured to send the digital note to a desktop of the second user, a calendar of the second user, a real-time communication client of the second user, and a profile of the second user, potentially among other locations. These tools may also display, on the real-time communication client, one or more digital notes that have been sent by one or more other users and received at the real-time communication client associated with the first user. These notes may be displayed individually or collectively in the form of a notebook.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE CONTENTS

The detailed description is described with reference to accompanying figures. In the figures, the left-most digit(s) of a reference number identifies the figure in which the reference number first appears. The use of the same reference numbers in different figures indicates similar or identical items.

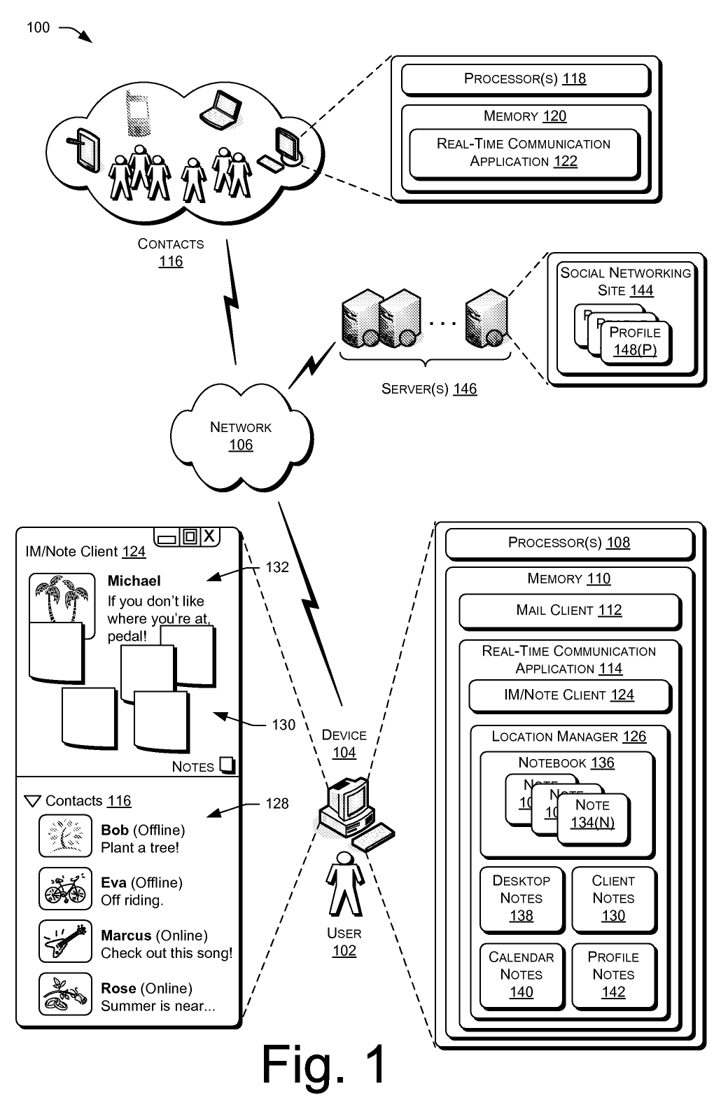

FIG. 1 depicts an illustrative architecture in which a user may send and receive digital notes.

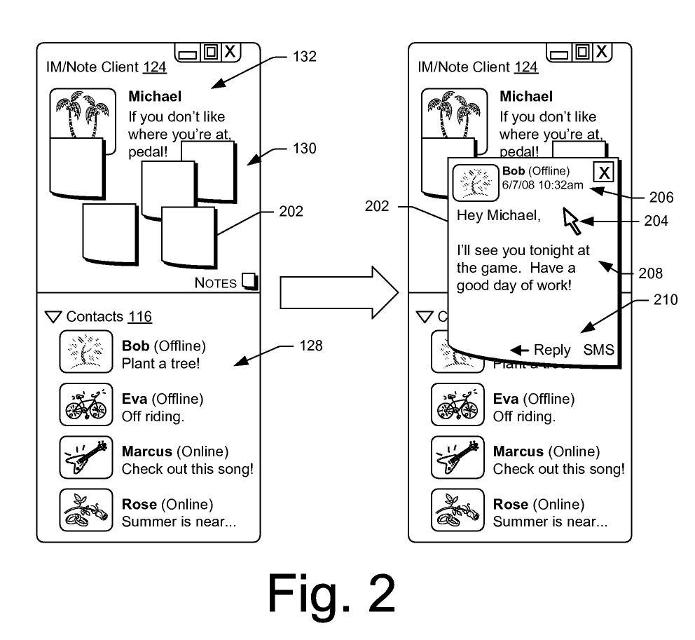

FIG. 2 depicts an illustrative user interface (UI) of a real-time communication client that displays multiple digital notes. The first UI represents the client when a cursor resides in a location other than over the digital notes, while the second UI represents the client when the cursor hovers over one of the displayed digital notes. As these UIs illustrate, the note may expand when the cursor hovers over that particular note.

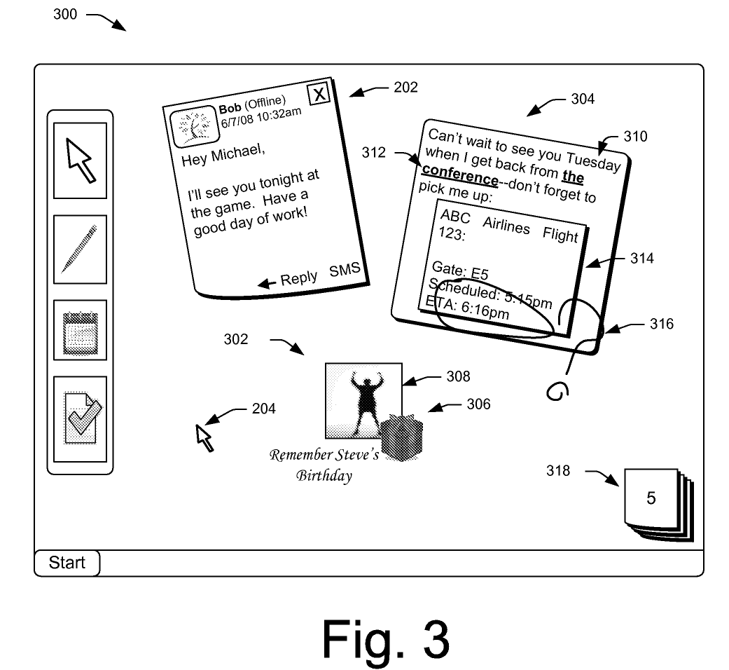

FIG. 3 depicts a user's desktop, which includes multiple digital notes. As illustrated, these notes may comprise varying types of content.

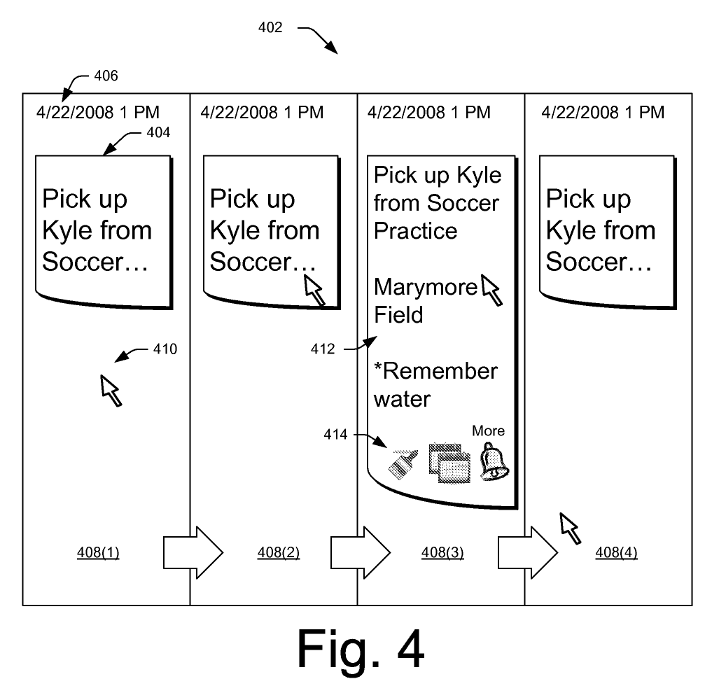

FIG. 4 depicts another location in which digital notes may reside. Here, digital notes reside on a calendar of a user. Similar to the UIs from FIG. 2, each of these notes may expand when a cursor hovers over the corresponding note.

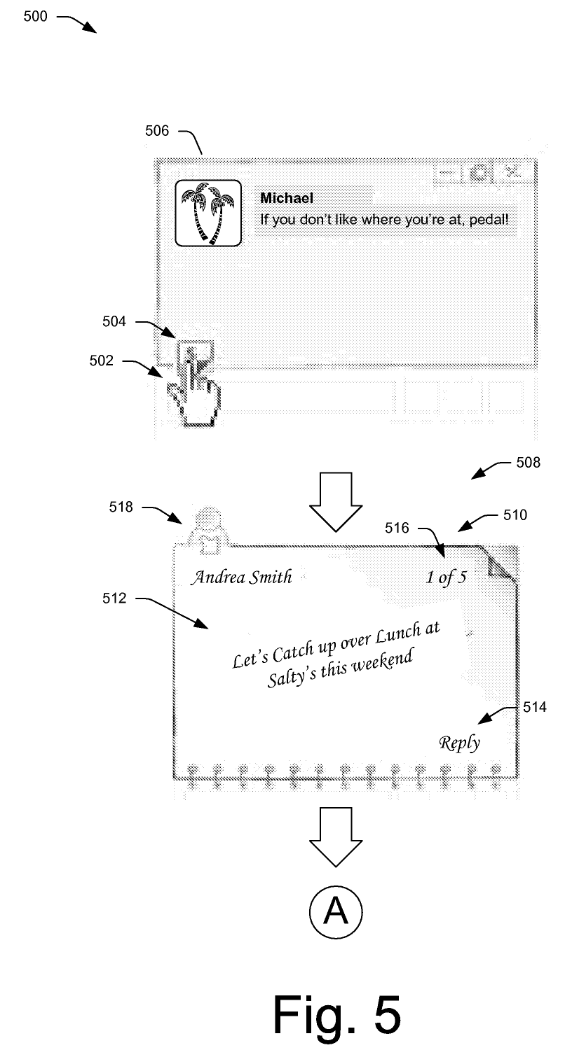

FIGS. 5-7 depict an illustrative flow diagram as a user chooses to view digital notes in a notebook. The flow diagram includes the user selecting to view the notebook, viewing two different notes in the notebook, and replying to a note with another note.

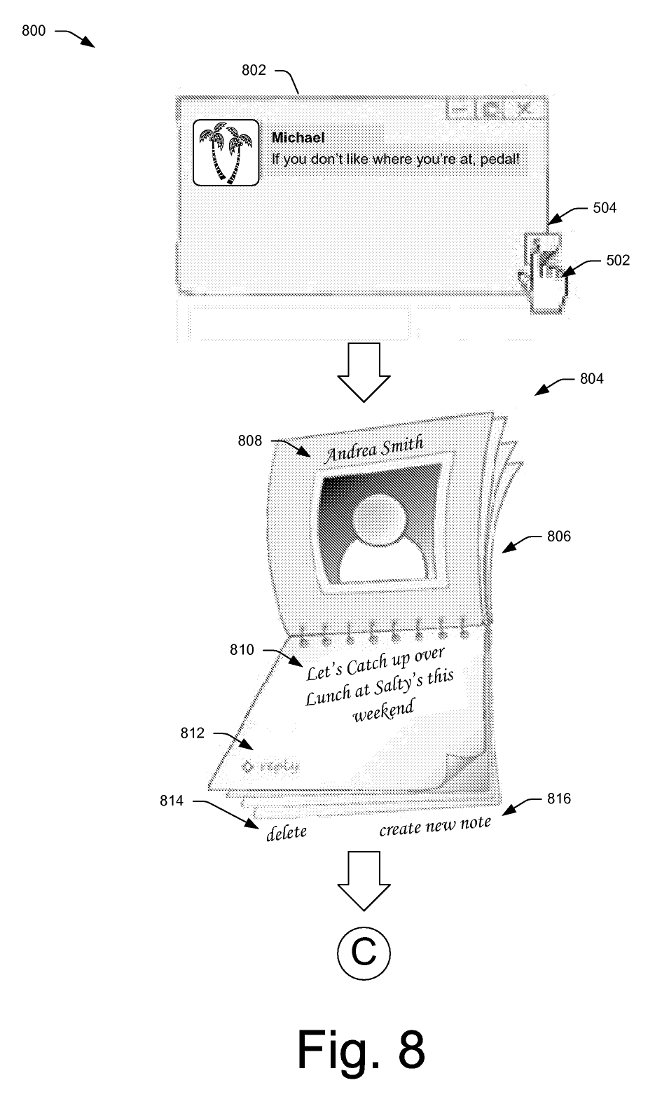

FIGS. 8-12 depict another illustrative flow diagram as a user chooses to view digital notes in a notebook. The flow diagram includes the user selecting to view the notebook, viewing two different notes in the notebook, replying to a note with another note, and selecting a format for the new note. This flow diagram also illustrates the user tearing an existing note from the notebook and moving the note to a different location. Once the note has been torn and removed, the flow diagram illustrates that the user then views the next note in the notebook, which corresponds to a personal note created by the user.

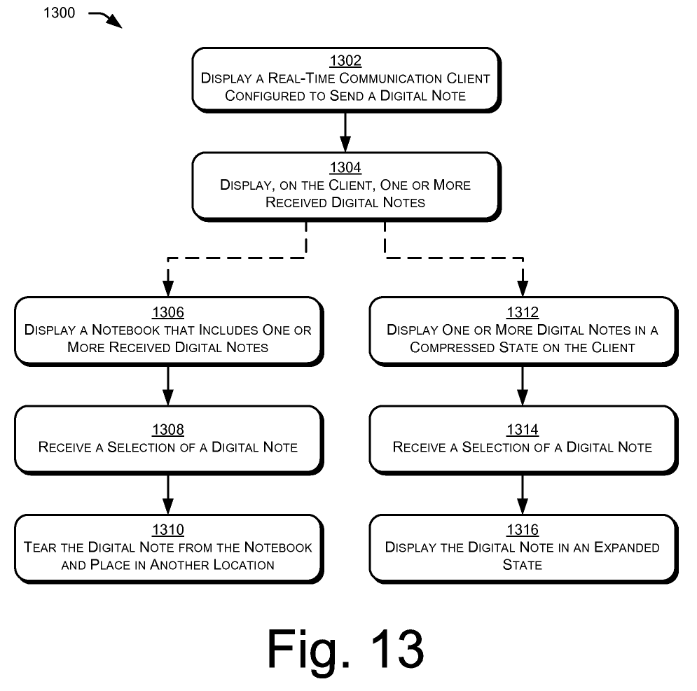

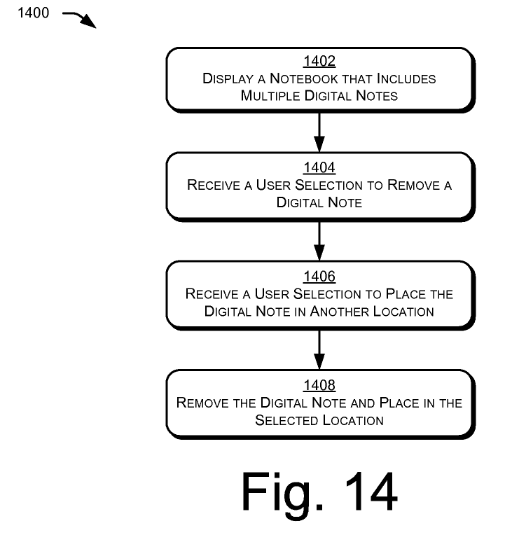

FIGS. 13-14 depict illustrative processes for employing the digital notes of the previous figures.

### DETAILED DESCRIPTION

This document describes tools for sending and receiving digital notes capable of comprise varying types of content and capable of being viewed in varying locations. The discussion begins with a section entitled “Illustrative Architecture”, which describes one non-limiting environment that may implement the claimed tools. A section entitled “Illustrative Digital Notes” follows. This section depicts and describes illustrative examples of digital notes that the architecture of FIG. 1, as well as other architectures, may employ. A third section, entitled “Illustrative Flow Diagrams”, depicts and describes how a user may view and otherwise interact with the created digital notes. Finally, a section entitled “Illustrative Processes” describes how digital notes from the architecture of FIG. 1, as well as other architectures, may be employed.

This brief introduction, including section titles and corresponding summaries, is provided for the reader's convenience and is not intended to limit the scope of the claims, nor the proceeding sections.

### Illustrative Architecture

FIG. 1 depicts an illustrative architecture 100 that may employ the described techniques. As illustrated, FIG. 1 includes a user 102 operating a computing device 104 for the purpose of sending and receiving digital notes over a network 106. Computing device 104 may comprise any sort of computing device, such as a personal computer, a laptop computer, a mobile phone, a set-top box, a game console, a personal digital assistant (PDA), a portable media player (PMP) (e.g., a portable video player (PVP) or a digital audio player (DAP)), and the like. Network 106, meanwhile, may comprise the Internet, a Local Area Network (LAN), a Wide Area Network (WAN), a wireless network, and/or the like.

As illustrated, computing device 104 includes one or more processors 108, as well as memory 110, upon which a mail client 112 and/or a real-time communication application 114 may reside. Mail client 112 may comprise a client that allows user 102 to send and receive email messages and/or the digital notes described herein. Real-time communication application 114, meanwhile, allows user 102 to communicate with other computing devices and other users substantially in real time. For instance, application 114 may allow user 102 to send and receive instant messages (IMs), short messaging service (SMS) messages (i.e. “text messages”), and/or the like, as well as digital notes as discussed in detail below. As illustrated, application 114 may allow user 102 to communicate with, for instance, a group of contacts 116. Each user of contacts 116 may similarly operate a respective computing device, which may include one or more processors 118 and memory 120. Memory 120 may store a real-time communication application 122, which may comprise the same or a different application than application 114 stored on computing device 104 of user 102.

As illustrated, real-time communication application 114 may comprise a client 124 (here, an IM/Digital Note client) and a location manager 126. Client 124 comprises a user interface (UI) that may enable user 102 to send and/or receive one or more types of real-time communications. Here, client 124 allows user 102 to send instant messages as well as digital notes to one or more other users, such contacts 116. Of course, while client 124 here allows the sending and receiving of instant messages in addition to digital notes, other implementations may employ a client that enables digital notes alone or digital notes in addition to one or more other forms of real-time communications. Furthermore, it is specifically noted that, in some instances, user 102 may send digital notes from one or more other locations. For instance, user 102 may be able to send digital notes from mail client 112, from a social networking website, from a user's calendar, and/or from many other locations.

As FIG. 1 illustrates, IM/note client 124 may include a list 128 of contacts 116. User 102 may accordingly employ list 128 to select a contact from list 128 in order to send an instant message or a digital note to the selected contact. Of course, user 102 may also employ client 124 to send an instant message or a note to a contact that list 128 does not include.

Client 124 also illustrates that user 102 has received multiple digital notes 130 from users, such as illustrated contacts 116. Digital notes comprise a form of real-time communication that bridges a gap between asynchronous communications, such as email and messages posted to a user's online profile, and synchronous communications, such as instant messaging, text messaging, or the like. As discussed and illustrated in detail below, digital notes may allow a user, such as user 102 to post a note in one or more of multiple locations for viewing by the recipient of the note. While the notes may be posted in real-time or substantially in real time, the format of the notes may be such that a recipient of a note does not feel compelled to respond to the received note.

As described and illustrated in detail below, these digital notes may take the form of a traditional “Post-It®” note, or may take any other form. Furthermore, these digital notes may comprise varying types of content, including static content and/or dynamic content. Static content may include, for instance, plain text, digital photographs, hyperlinks, and/or any other type of static content. Dynamic content, meanwhile, may comprise video clips, audio clips, animations, self-updating content, and/or any other type of dynamic content. In some instances, a first user may send a digital note to a second user. The second user, meanwhile, may modify the note and send the modified note back to the first user. As such, each user's device may display a synchronized copy of the note. When either user modifies the note, the other user's copy of the note may accordingly be updated. As such, digital notes may include collaborative content in some instances.

Regardless of the content, one or more of the digital notes may be associated with and displayed on IM/Note client 124. As illustrated, notes 130 appear located on top of a profile area 132 of client 124. Of course, in other implementations, some or all of notes 130 may be located in one or more other areas in lieu of or in addition to client 124.

As discussed above, client 124 includes location manager 126, which manages the location(s) of sent and received digital notes amongst one or more locations. For instance, location manager 126 may maintain one or more notes 134(1), (2), . . . , (N) in a notebook 136. Here, notebook 136 may take the form of a digital notebook and may, in some instances, be displayed on IM/note client 124, as illustrated and described below with reference to FIGS. 5 and 8. When a user receives a digital note, the digital note may be stored in the notebook, in addition or in the alternative to being stored or displayed in one or more other locations. In some instances, each received digital note is automatically stored in notebook 136.

Location manager 126 may also maintain a location of desktop notes 138, client notes 130, calendar notes 140, and/or profile notes 142. As the name suggests, desktop notes 138 may be located and displayed on a desktop of computing device 104 of user 102. As such, desktop notes 138 may be displayed as digital Post-It® notes that are affixed on the user's desktop, as illustrated in FIG. 3. Client notes 130, meanwhile, may be located and displayed on client 124, as discussed above.

Next, calendar notes 140 may reside and be displayed on a calendar associated with user 102. For instance, mail client 112 may maintain a calendar that user 102 may employ to track appointments, meetings, and the like. Calendar notes 140, which may be associated with a date and time, may be displayed on a calendar at a corresponding date and time. FIG. 4 depicts an illustrative calendar note and is described in more detail below.

Finally, profile notes 142 may appear on a profile (e.g., a social networking profile) associated with user 102. For instance, FIG. 1 illustrates that user 102 may access a social networking site 144, maintained by one or more servers 146, via network 106. Also as illustrated, social networking site 144 may store one or more user profiles 148(1), (2), . . . (P). Here, one (or more) of profiles 148(1)-(P) may correspond to user 102. Profile notes 142 may therefore appear on the corresponding profile of user. As such, user 102 may view profile notes 142 when user 102 accesses social networking site 144.

In some instances, a note sent to a profile or a client may be made public or may be kept private. That is, such a note may be viewed by users other than the receiving user in the case of the public note, or may be viewed only by the receiving user in the case of a private note. In one instance, to create a public note a sending user may specify that that the note is intended to be public and the receiving user may then either affirm or deny the request for the note to be made public.

In sum, FIG. 1 illustrates that user 102 may send and/or receive digital notes having varying types of content to varying locations. For instance, user 102 may send a digital note to one or more of contacts 116 that is viewable by the recipient on a desktop of the recipient, a client of the recipient, a calendar of the recipient, a profile of the recipient, or a combination thereof. In some instance, a recipient of a digital note may view the received note in each location. Furthermore, note that these digital notes may be sent to still other locations in other instances. Finally, while FIG. 1 illustrates one possible architecture, it is specifically noted that many other similar or different architectures may employ the described and claimed digital notes.

### Illustrative Digital Notes

FIG. 2 depicts an example IM/note client 124 from FIG. 1. As illustrated in FIG. 1, client 124 includes a list of contacts 128, as well as digital notes 130 displayed over profile area 132. Here, profile area 132 includes five digital notes that other users have sent to the client of the illustrated user 102 (“Michael”), including a digital note 202. In some instances, each of the represented five digital notes comprises a compressed version of a digital note. A compressed version of the digital note may include no details of the note, some details of the note, or all details of the note. When user 102 selects the compressed digital note, meanwhile, the note may expand.

FIG. 2, for instance, illustrates that user 102 operates a cursor 204. When user 102 moves cursor 204 over digital note 202, note 202 expands. While FIG. 2 illustrates expansion of digital note 202 in response to hovering of cursor 204, other implementations may expand the note in response to any other type of selection. When the note expands, additional details or content of the note may be displayed.

For instance, FIG. 2 illustrates that expanded note 202 includes an area 206 that lists information about the contact or user that sent the note to user 102. Here, for instance, area 206 indicates a name of the sending user (“Bob”), a current status of the sending user (e.g., whether the user is currently online or offline), as well as a date and time that the note was sent and/or received (“6/7/2008 10:32 am”). In the illustrated implementation, area 206 also includes an icon or other object (e.g., a picture, video clip, etc.) associated with and selected by the sending user.

Digital note 202 may also display content 208 when the note expands. Here, content 208 comprises a plain-text message. In other instances, however, content 208 of note 202 may comprise any type of static and/or dynamic content. Static content may include, for instance, plain text, digital photographs, hyperlinks, and/or any other type of static content. Dynamic content, meanwhile, may comprise video clips, audio clips, animations, self-updating content, and/or any other type of dynamic content.

Furthermore, the sending user may create content 208 and/or another entity may create the content. For instance, some implementations may allow an advertiser to include advertisements on selected digital notes. As such, the advertiser creates a portion of the content (e.g., the advertisement), while the sending user creates another portion of the content (e.g., the message).

Finally, digital note 202 includes an area 210 that includes an icon that, when selected by user 102, allows user 102 to reply to note 202. Area 210 may also include an icon that, when selected, allows user 102 to send a short messaging service (SMS) message (i.e., a text message) to the corresponding user, Bob. Of course, other implementations may allow user 102 to reply to note 202 in other ways, or may not allow user 102 to reply to note 202 at all.

FIG. 3 depicts other illustrative notes that the architecture of FIG. 1 may employ. Here, FIG. 3 includes a desktop 300 associated with computing device 104 of user 102. Desktop 300 includes digital note 202 from FIGS. 1 and 2, as well as a digital note 302 and a digital note 304. User 102 may have placed one or more of these desktop-based digital notes onto desktop 300, and/or other users may have sent one or more of these digital notes to desktop 300 of user 102. For instance, user 102 may have moved digital note 202 from client 124 and onto desktop 300. That is, user 102 may have employed cursor 204 to drag-and-drop note 202 from client 124 (or another location) and onto desktop 300.

Furthermore, user 102 may have created digital note 302 for his or herself on desktop 300. That is, user 102 may have employed client 124 to create a note for his or herself on the desktop. As FIG. 3 illustrates, user 102 likely created note 302 and placed the note on desktop 300 in order to help “Remember Steve's Birthday”. In addition to this text, note 302 also includes a piece of clip-art 306 as well as a digital photograph 308. Of course, note 302 may include still other types of content as discussed above.

User 102 may also receive digital notes onto his or her desktop 300. For instance, user 102 may her have received digital note 304 from another user, such as one of contacts 116 from FIG. 1. To do so, this sending user may have specified to send note 304 to desktop 300 of user 102, possibly in addition to other locations (e.g., client 124, a social networking profile of user 102, etc.). Alternatively, the sending user may merely choose to send note 304 to user 102, who may then view note 304 in one or more default locations. In some instances, note 304 is automatically displayed in several locations, such as desktop 300, client 124, a social networking profile, a calendar, and/or the like.

As illustrated, note 304 includes text 310, as well as a hyperlink 312 (“the conference”) that, when selected by user 102, causes computing device 104 to render a webpage associated with the hyperlink. Additionally, note 304 here includes self-updating content 314. As the name suggest, self-updating content 214 may automatically update without user interaction. As such, the content of note 304 on desktop 300 may change without the sending user or the receiving user (user 102) modifying the note. Here, self-updating content 314 comprises a flight status for “ABC Airlines Flight 123”. Content 314 lists that while this flight was scheduled to land at 5:15 pm, the current estimated time or arrival (ETA) is set for 6:16 pm. Furthermore, if ABC Airlines should changes this ETA, content 314 and note 304 may automatically update to reflect this change. Desktop 300 also illustrates that note 304 includes user annotations 316 made by user 102.

Finally, desktop 300 may display an icon 318 associated with a notebook, which is configured to comprise multiple digital notes. That is, the notebook may hold or consist of digital notes that user 102 has received and/or created. Here, icon 318 indicates that the notebook currently stores or holds five digital notes. Therefore, when user 102 selects icon 318, user 102 may scroll through the five different digital notes. In some instances, user 102 may also move a note from the notebook to another location or locations, such as to desktop 300, client 124, a social networking profile associated with the user, a calendar associated with the user, and/or to another location. While the illustrated implementation depicts icon 318 as residing on desktop 300, icon 318 associated with the notebook may additionally or alternatively reside in one or more other locations (e.g., client 124, etc.). FIGS. 5-10 and an accompanying discussion illustrate and described the notebook in greater detail below.

FIG. 4 illustrates a calendar 402 of user 102, which comprises yet another location in which digital notes may be sent, received, or otherwise placed. Here, FIG. 4 illustrates a portion of calendar 402 that includes a digital note 404 as user 102 expands and collapses the digital note. In this example, the illustrated portion is associated with a time and date 406 (4/22/2008, 1 pm) of calendar 402.

In some instances, user 102 may have placed digital note 404 onto calendar. In other instances, another user may have sent digital note 404 to user 102, resulting in digital note 404 appearing on calendar. To do so, the sending user may have explicitly sent the note to time and date 406 of calendar 402 or, conversely, the note may have been placed on calendar 402 automatically. That is, if digital note 404 were associated with a particular date and time, then the note may be automatically placed on the user's calendar 402 in response to receiving the note.

FIG. 4 begins at a first time 408(1) before user 102 has chosen to expand digital note 404. As described above with reference to FIG. 2, digital note 404 may remain compressed until user 102 selects the note in order to expand and view the note in its entirety. When user 102 selects note 404, however, note 404 may expand. Here, user 102 selects note 404 by hovering a cursor 410 over digital note 404 at a time 408(2). In response, note 404 expands at a time 408(3).

As illustrated, digital note 404 may display additional content 412 (e.g., text, pictures, etc.) as well as one or more icons 414 in an expanded state. Icons 414 may allow user 102 to modify properties of digital note 404. For instance, these icons may allow user 102 to change a background or text color of the note, to move the note to a different time and date on calendar 402, to create or alter a reminder for the appointment represented by note 404, and/or may provide user 102 with other options. Finally, user 102 deselects note 404 at a time 408(4) by removing cursor 410 from its hovering position over note 404. In response, note 404 returns to its compressed state.

### Illustrative Flow Diagrams

FIGS. 5-7 depict an illustrative flow diagram 500 as a user, such as user 102, chooses to view digital notes in a notebook. The flow diagram includes the user selecting to view the notebook, viewing two different notes in the notebook, and replying to a note with another note.

Flow diagram 500 begins at FIG. 5, which illustrates user 102 operating a cursor 502 to select an icon 504 of a notebook from an illustrative IM/Note client 506. Client 506 may be similar or different to client 124, described above and illustrated in FIGS. 1 and 2. Similarly, the notebook associated with icon 504 may be similar or different to the notebook associated with icon 318, described above and illustrated in FIG. 3. Again, icon 504 here indicates that the notebook currently contains five digital notes. These digital notes may comprise notes received from other users, notes created by user 102 and saved in the notebook, or a combination thereof.

Once user 102 selects icon 504 with cursor 502, a notebook 508 and a first digital note 510 is displayed. As illustrated, notebook 508 may take the form of a physical notebook. That is, notebook 508 may take the form of a spiral notebook having notebook rings. Of course, in other implementations, notebook 508 may take numerous other forms.

As illustrated, digital note 510 includes content 512 (here, a plan-text message) and an icon 514 that, when selected, allows user 102 to reply to the digital note. Additionally, digital note 510 includes an area 516 that indicates a total number of digital notes currently stored in notebook 508, as well as the number of the note that is currently displayed. Finally, note 510 includes an icon 518 that, when selected, result's in the user's exit from notebook 508 and the return to the display of client 506.

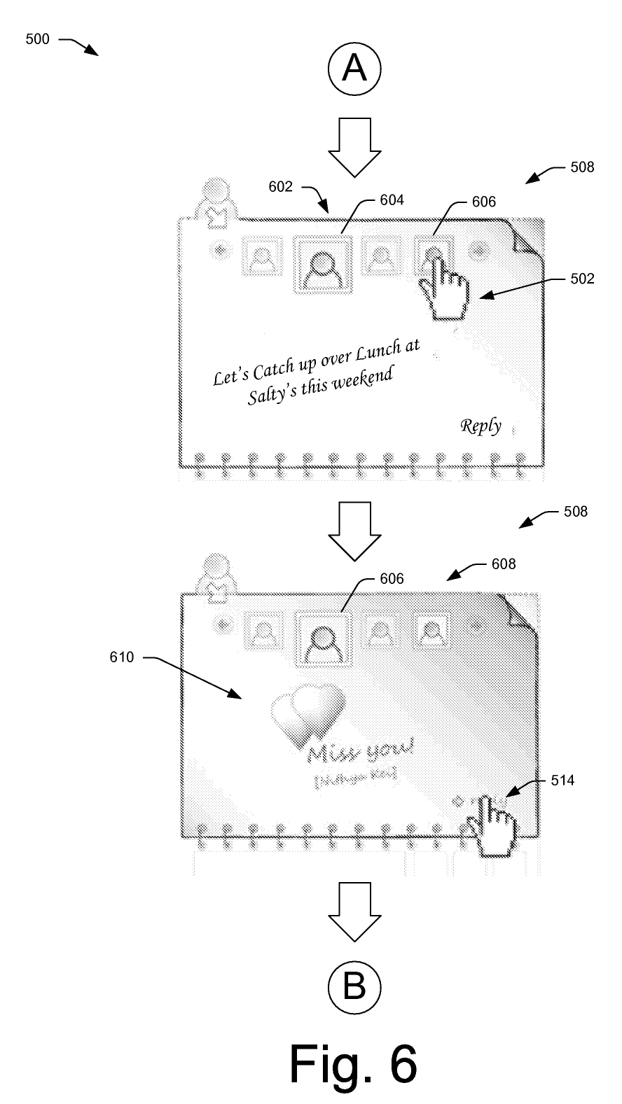

FIG. 6 continues flow diagram 500 after user 102 moves cursor 502 over area 516 of FIG. 5. In response to this hovering, digital note 510 displays a list 602 that identifies other users who have sent, to user 102, a digital note that is currently stored in notebook 508. As illustrated, list 602 may somehow highlight an icon 604 associated with the user or contact who sent digital note 510 (the note currently being viewed). Additionally, list 602 includes an icon 606 associated with another user who has sent a note to user 102.

After user 102 selects (via cursor 502 or other selection means) icon 606, a digital note 608 sent by the corresponding user may be displayed. As illustrated, note 608 here includes content 610. Content 610 includes a colored background, a piece of clip art (two hearts), as well as a plain-text message (“Miss You! . . . ”). Finally, note 608 includes icon 514, discussed above and entitled “Reply”.

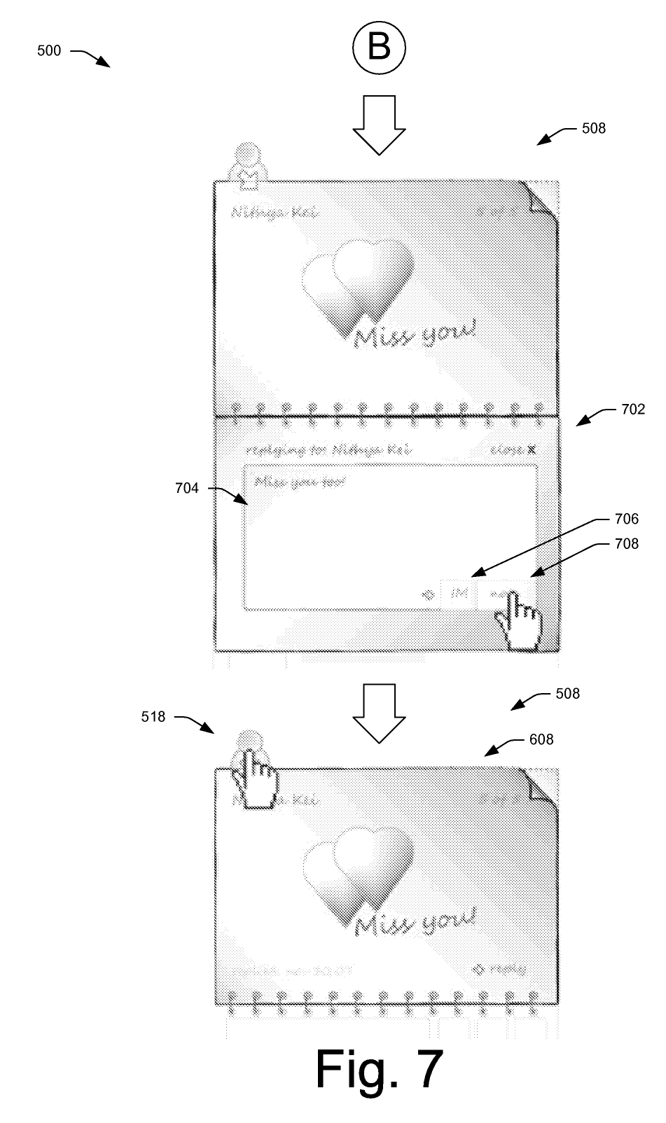

FIG. 7 continues flow diagram 500 after user 102 selects reply icon 514. In response, notebook 508 displays a reply pane 702. Reply pane 702 may include a text box 704 that allows user 102 insert text or other content (e.g., pictures, hyperlinks, video clips, etc.). Additionally, reply pane 702 includes an icon 706, entitled “IM”, that allows user 102 to reply to note 608 as an instant message. Reply pane 702 also includes an icon 708, entitled “Note”, that allows user 102 to reply to note 608 as a digital note. Of course, other implementations may allow user 102 to reply to note 608 in additional or alternative manners. Here, user 102 selects, via cursor 502 to send the reply as a digital note. After sending the reply in the illustrated example, user 102 selects icon 518. In response, notebook 508 is closed and user 102 returns to client 506, as illustrated in FIG. 5.

FIGS. 8-12 depict another illustrative flow diagram 800 as a user chooses to view digital notes in a notebook. The flow diagram includes the user selecting to view the notebook, viewing two different notes in the notebook, replying to a note with another note, and selecting a format for the new note. Flow diagram 800 also illustrates the user tearing an existing note from the notebook and moving the note to a different location. Once the note has been torn and removed, the flow diagram illustrates that the user then views the next note in the notebook, which corresponds to a personal note created by the user in the illustrated example.

FIG. 8 begins flow diagram 800, which again includes user 102 selecting icon 504 with cursor 502 on an IM/note client 802. In response, client 802 displays a notebook 804, beginning with a first digital note 806. Again, digital note 806 may include a portion 808 that identifies a user who sent the digital note to user 102. Here, portion 808 includes a picture or other icon associated with the user as well as a name or other identifier of the user (“Andrea Smith”). Note 806 also includes content 810, as well as an icon 812 entitled “Reply”. Digital note 806 also includes an icon 814 that, when selected, deletes digital note 806. Finally, digital note 806 includes an icon 816 (“Create New Note”) that, when selected, allows user 102 to create and send a new digital note.

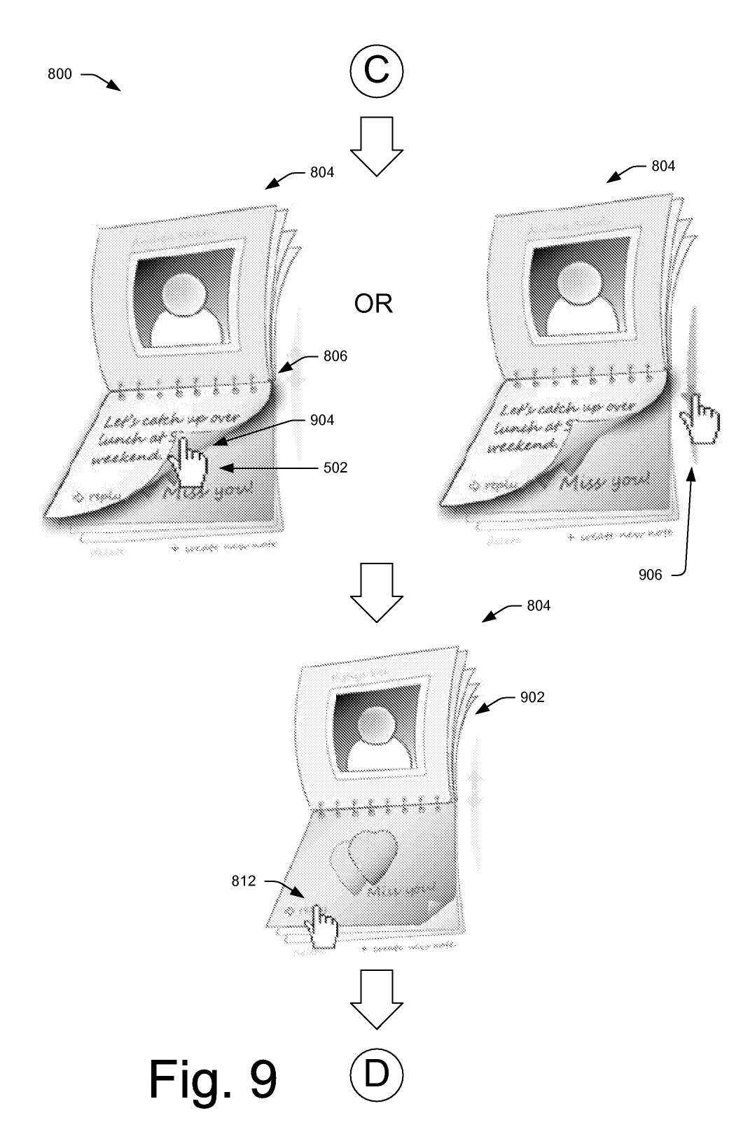

FIG. 9 continues the illustration of flow diagram 800. Here, user 102 chooses to view a subsequent digital note 902 in notebook 804. To do so, notebook 804 may allow user 102 to select, with cursor 502 or otherwise, a corner 904 of digital note 806. User 102 may then drag and drop corner 904 in order to view subsequent digital note 902. Conversely or additionally, notebook 804 may include a slider 906 that allows user 102 to scroll between different notes in notebook 804. For instance, notebook 804 may allow user 102 to scroll up and down slider 906 with user of cursor 502. Of course, while a few illustrative methods for changing a currently-displayed note have been illustrated and discussed, it is to be appreciated that notebook 804 may employ many other similar or different techniques.

After user 102 has flipped the page of notebook 804, notebook 804 may display digital note 902. Again, digital note 902 may include icon 812, entitled “Reply”. When selected, icon 812 may allow user 102 to respond to the currently-displayed digital note 902.

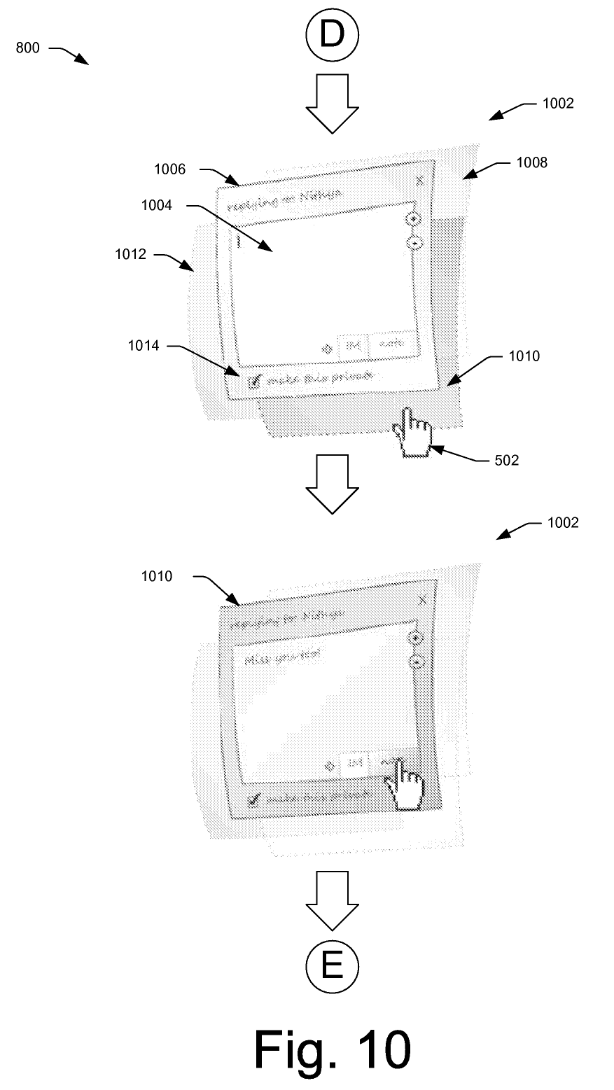

FIG. 10 continues flow diagram 800 after user 102 has chosen to reply to digital note 902 by selecting icon 812. In response to selecting icon 812, a reply pane 1002 is displayed. Similar to reply pane 702, reply pane 1002 includes a text box 1004 that allows user 102 to provide content. Reply pane 1002 also allows user 102 to send the replay as an instant message or a note. Again, other implementations may allow user 102 to reply via other communication techniques.

Here, reply pane 1002 further allows user to select one of a number of note styles to send as a reply. For instance, FIG. 10 illustrates a first style 1006, a second style 1008, a third style 1010, and a fourth style 1012. These varying styles may include varying designs, colors, and/or any other differing designs. Here, each of the four styles comprises a different color background. As illustrated, user 102 may select one of styles 1006-1012 by selecting a desired style with cursor 502. While the current example allows user 102 to select one of four styles, other implementations may allow selection of any other number of styles.

Finally, regardless of the style chosen, reply pane 1002 includes an area 1014 that allows user 102 to decide whether to send a “private” note or a “public” note. In some instances, a private note is only viewable by the recipient of the note, while a public note may be viewed by others if the note is posted to a public location, such as a social networking site profile of the receiving user. In some instances, even if user 102 chooses to send a public note, a receiving user must consent to the note's being made public in order for others to view the note. As FIG. 10 further illustrates, in the current example user 102 selects third style 1010 as a format for the note. Furthermore, FIG. 10 illustrates that user 102 wishes to keep the note private.

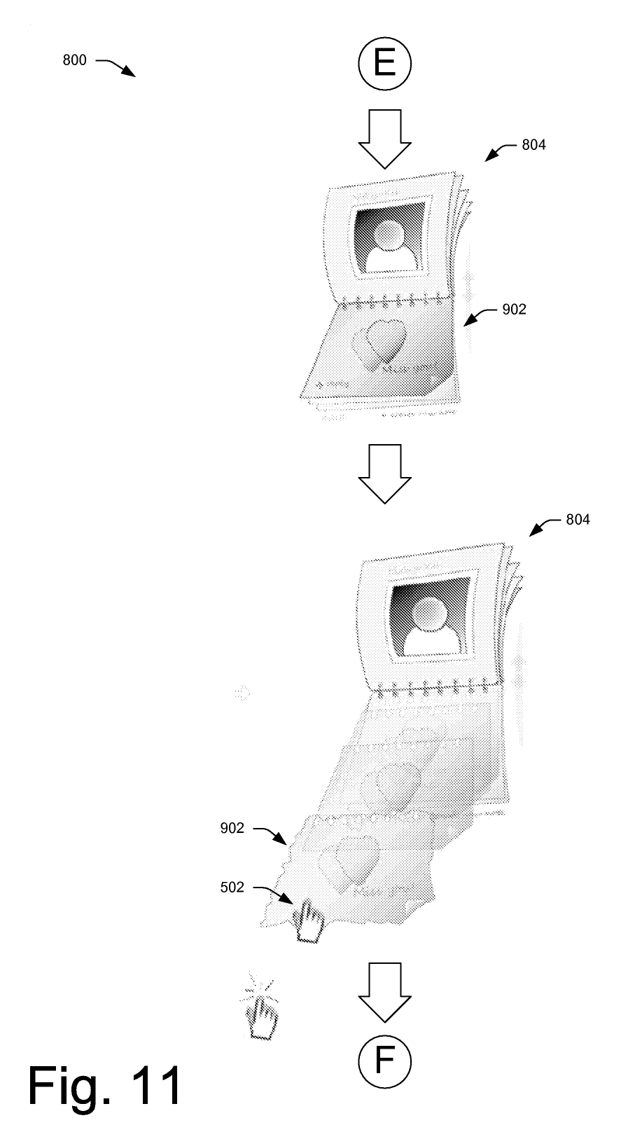

FIG. 11 continues the illustration of flow diagram 800 after user 102 sends the reply note. In the illustrated example, notebook 804 returns to the display of digital note 902. FIG. 11 also illustrates that user 102 may move a digital note from notebook 804 to another location. Here, user 102 selects digital note 902 and removes (e.g., “tears”) the note from notebook 804 in order to drag and drop the note to a different location. In some instances, user 102 may move note 902 to a desktop of the user (e.g., desktop 300), a note client of the user (e.g., IM/note client 124), a calendar of the user (e.g., calendar 402), a profile of the user (e.g., social networking profile 144(P)), and/or to another location. As such, digital notes may create a roaming experience where user 102 is able to move and view notes amongst many different locations. Similarly, user 102 may send notes to other users in some or all of the same locations.

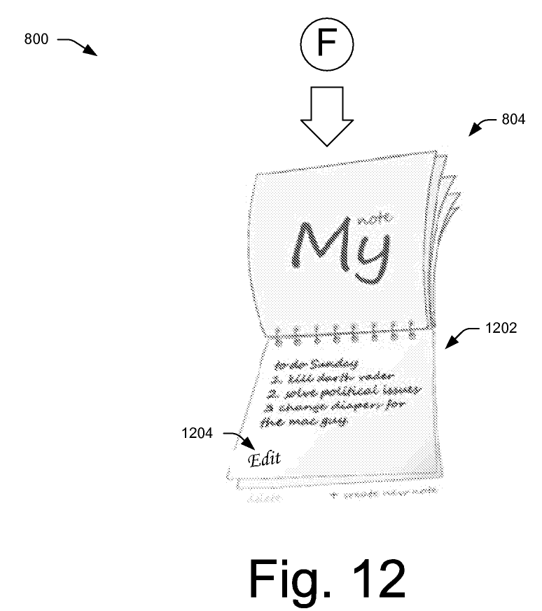

FIG. 12 continues the illustration of flow diagram 800 after user 102 has removed digital note 902 from notebook 804. Here, notebook 804 displays the next note in notebook 804, digital note 1202. As illustrated, digital note 1202 is a personal note created by user 102 and comprising a to-do list for the user. Because note 1202 is a personal note, this note may include an icon 1204 (“edit”) that, when selected, allows user 102 to edit the note.

### Illustrative Processes

FIGS. 13-14 depict illustrative processes 1300 and 1400 for employing the digital notes described above. These processes, as well as other processes described throughout, are illustrated as a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

Process 1300 includes operation 1302, which represents displaying a real-time communication client associated with a first user. The real-time communication client may be configured to receive an input from the first user and send, in response, a digital note to a second user, wherein the real-time communication client is configured to send the digital note to a desktop of the second user, a calendar of the second user, a real-time communication client of the second user, and a profile of the second user. For instance, the client may be configured to send the digital note to one or a combination of these locations (e.g., each location). The digital note may comprise static content, dynamic content, and/or self-updating content. Furthermore, in some instances, the displayed client may be configured to send and/or receive instant messages and/or other forms of communication.

Next, operation 1304 represents displaying, on the real-time communication client, one or more digital notes that have been sent by one or more other users and received at the real-time communication client associated with the first user. In some instances, these displayed digital notes may appear individually on the client, as FIGS. 1 and 2 illustrate. Alternatively or additionally, the digital notes may be displayed within a notebook that is displayed on the real-time communication client or in another location (e.g., a desktop of the user), as FIGS. 3, 5, and 8 illustrate. Also as discussed above, selection of the notebook may allow the user to scroll through each of the one or more digital notes.

Process 1300 may then proceed to operations 1306-1310 and/or to operations 1312-1316. Operation 1306 represents the displaying of the notebook that includes one or more digital notes that have been received by the first user. Next, operation 1308 receives a selection of a digital note in the notebook and, in response, operation 1310 tears the selected digital note from the notebook and places the selected digital note in another location. The selection of the digital note may comprise the first user dragging the note from the notebook and dropping the note in another location. This location may comprise, without limitation, the desktop of the user, a calendar of the user, the real-time communication client of the user, and/or a profile of the user.

Operation 1312, meanwhile, represents individually displaying the one or more digital notes on the real-time communication client, as FIGS. 1 and 2 illustrate. Here, the notes may be displayed in a compressed state. Next, operation 1314 receives a user selection of one of the one or more digital notes and, in response, operation 1316 displays the selected digital note in an expanded state. In some instances, the selected digital note displays, in the expanded state, content of the digital note that is not displayed in the compressed state. This content may include, for instance, a message from a sending user to the first user. While the first user may select the digital in many ways, one non-limiting example comprises the first user hovering a cursor over the selected digital note.

FIG. 14 illustrates process 1400, which includes displaying a notebook associated with a user at operation 1402. The displayed notebook includes multiple digital notes sent over a network to the user, the digital notes being configured to include static, dynamic, and self-updating content. Next, operation 1404 represents receiving a user selection to remove a digital note from the displayed notebook. This may include a user selecting the digital note with a cursor, among many other types of selection. Operation 1406 then receives a user selection to place the selected digital note in a location other than the displayed notebook. This location may comprise, among others, a desktop of the user, a calendar of the user, a real-time communication client of the user, or a social networking profile of the user. In response to the receiving of the user selections, operation 1408 represents removing the digital note from the displayed notebook and placing the selected digital note in the location other than the displayed notebook. As such, the user is able to tear a digital note from displayed notebook and move the digital note to one or more other locations.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system comprising:
one or more processors;
memory;
a real-time communication client, stored in the memory and executable on the one or more processors, associated with a user and configured to send and receive instant messages and send and receive digital notes; and
a location manager, stored in the memory and executable on the one or more processors, configured to: (i) manage a location of each of the received digital notes, the locations comprising the real-time communications client of the user, a desktop of the user, and a calendar of the user; (ii) store multiple digital notes in a notebook, the notebook being displayed on the real-time communications client; and (iii) move a digital note from the notebook to the real-time communications client of the user, the desktop of the user, or the calendar of the user in response to receiving a user selection to move the digital note.

2. A system as recited in claim 1, wherein the digital notes comprise static content and dynamic content.

3. A system as recited in claim 1, wherein the digital notes comprise self-updating content.

4. A system as recited in claim 1, wherein the digital notes comprise text, digital photographs, hyperlinks, video clips, audio clips, and interactive content.

5. One or more computer-readable media storing computer-executable instructions that, when executed on one or more processors, perform acts comprising:
displaying a real-time communication client associated with a first user, the real-time communication client configured to receive an input from the first user and send, in response, a digital note to a second user, wherein the real-time communication client is configured to send the digital note to a desktop of the second user, a calendar of the second user, a real-time communication client of the second user, and a profile of the second user; and
displaying, on the real-time communication client, one or more digital notes that have been sent by one or more other users and received at the real-time communication client associated with the first user.

6. One or more computer-readable media as recited in claim 5, wherein the real-time communication client associated with the first user is configured to send, in response to the receiving of the input from the first user, a single digital note to the desktop of the second user, the calendar of the second user, the real-time communication client of the second user, or the profile of the second user.

7. One or more computer-readable media as recited in claim 5, wherein the real-time communication client associated with the first user is configured to send, in response to the receiving of the input from the first user, a single digital note to two or more of: the desktop of the second user, the calendar of the second user, the real-time communication client of the second user, or the profile of the second user.

8. One or more computer-readable media as recited in claim 5, wherein the real-time communication client associated with the first user is configured to send a digital note comprising static content, dynamic content, and self-updating content.

9. One or more computer-readable media as recited in 5, wherein the real-time communication client associated with the first user is further configured to send, in response to receiving an input from the first user, an instant message to the second user

10. One or more computer-readable media as recited in claim 5, wherein the one or more digital notes displayed on the real-time communication client appear within a notebook that is displayed on the real-time communication client, and wherein selection of the notebook allows the first user to scroll through each of the one or more digital notes.

11. One or more computer-readable media as recited in claim 5, further storing computer-executable instructions that, when executed on the one or more processors, perform acts comprising:
displaying a notebook that includes one or more digital notes that have been received by the first user;
receiving a selection of a digital note in the notebook;
in response to the receiving of the selection, tearing the selected digital note from the notebook and placing the selected digital note in another location.

12. One or more computer-readable media as recited in claim 11, wherein the another location comprises a desktop of the first user, a calendar of the first user, a calendar of the first user, or the real-time communication client of the first user.

13. One or more computer-readable media as recited in claim 5, further storing computer-executable instructions that, when executed on the one or more processors, perform acts comprising:
displaying the one or more digital notes on the real-time communication client in a compressed state;
receiving a user selection of one of the one or more digital notes;
in response to the receiving of the user selection, displaying the selected digital note in an expanded state.

14. One or more computer-readable media as recited in 13, wherein the selected digital note displays, in the expanded state, content of the digital note that is not displayed in the compressed state.

15. One or more computer-readable media as recited in 14, wherein the content that is displayed in the expanded state and not in the compressed state comprises a message from a sending user to the first user.

16. One or more computer-readable media as recited in 14, wherein the selection of the digital note comprises the first user hovering a cursor over the selected digital note.

17. One or more computing device comprising:
one or more processors; and
the one or more computer-readable media storing the computer-executable instructions as recited in claim 5.

18. One or more computer-readable media storing computer-executable instructions that, when executed on one or more processors, perform acts comprising:
displaying a notebook associated with a user, the notebook including multiple digital notes sent over a network to the user, the digital notes configured to include static, dynamic, and self-updating content;
receiving a user selection to remove a digital note from the displayed notebook;
receiving a user selection to place the selected digital note in a location other than the displayed notebook; and
in response to the receiving of the user selections, removing the digital note from the displayed notebook and placing the selected digital note in the location other than the displayed notebook.

19. One or more computer-readable media as recited in claim 18, wherein the location other than the displayed notebook comprises a desktop of the user, a calendar of the user, a real-time communication client of the user, or a social networking profile of the user.

20. One or more computing device comprising:
one or more processors; and
the one or more computer-readable media storing the computer-executable instructions as recited in claim 18.
